(19) United States
(12) Patent Application Publication
(10) Pub. No.: US 2025/0384532 A1
(43) Pub. Date: Dec. 18, 2025

(54) Methods and systems for preserving image features during image editing

(71) Applicant: Canva Pty Ltd, Surry Hills (AU)

(72) Inventors: Stefan Sietzen, Vienna (AT); Sanchit Sanchit, Vienna (AT); Alexander Tack, Vienna (AT)

(73) Assignee: Canva Pty Ltd, Surry Hills (AU)

(21) Appl. No.: 19/236,022

(22) Filed: Jun. 12, 2025

(30) Foreign Application Priority Data
Jun. 17, 2024 (AU) 2024204114

(51) Int. Cl. G06T 5/70

(52) U.S. Cl. CPC G06T 5/70; G06T 2207/20182

(57) ABSTRACT

Described embodiments generally relate to a computer-implemented method for editing an image. The method includes accessing an image; identifying at least a first area of the image and a second area of the image; configuring a model to generate an edited image based on the first area of the image and the second area of the image, wherein the edited image comprises a first area of the edited image and a second area of the edited image; wherein the model is configured to generate the edited image such that the first area of the edited image differs from the first area of the image less than the second area of the edited image differs from the second area of the image.

### CROSS-REFERENCE TO RELATED APPLICATION

This application is a U.S. Non-Provisional application that claims priority to and the benefit of Australian Patent Application No. 2024204114, filed Jun. 17, 2024, that is hereby incorporated by reference in its entirety.

### TECHNICAL FIELD

Described embodiments relate to systems, methods, and computer program products for performing image editing. In particular, described embodiments relate to systems, methods and computer program products for preserving image features while performing automatic editing of digital images.

### BACKGROUND

Digital image editing processes can be used to produce a wide variety of modifications to digital images. For example, colour properties of the image may be modified, image elements such as foreground or background objects may be removed or replaced, or image elements may be added.

Historically, digital image editing has been performed manually using digital image editing software to manipulate the image. However, this can be extremely long and tedious work if a high quality result is desired, especially when working with large areas. This is because this method can require a pixel-level manipulation of the image to retain a realistic and seamless result. Some automated approaches have been developed, but these often produce undesirable results. For example, some automatic image editing processes result in excessive or undesirable editing of the original image features.

It is desired to address or ameliorate one or more shortcomings or disadvantages associated with prior systems and methods for performing image editing, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments provide a method for editing an image, the method comprising:
accessing an image;
identifying at least a first area of the image and a second area of the image;
configuring a model to generate an edited image based on the first area of the image and the second area of the image, wherein the edited image comprises a first area of the edited image and a second area of the edited image;
wherein the model is configured to generate the edited image such that the first area of the edited image differs from the first area of the image less than the second area of the edited image differs from the second area of the image.

In some embodiments, configuring the model to generate an edited image may include performing a denoising process on the image. Configuring the model to generate an edited image may include: initialising a latent representation of the image; performing a denoising process on the latent representation; and generating an edited image from the latent representation.

Initialising the latent representation of the image may include converting the image from a pixel space to a latent space and applying random noise. The random noise may be Gaussian noise. In some embodiments, generating an edited image from the latent representation may include converting the latent representation back to the pixel space of the image.

In some embodiments, configuring the model to generate an edited image may include: determining a first set of parameters for the first area of the image; and determining a second set of parameters for the second area of the image. Performing a denoising process on the latent representation may include: generating an initial noise prediction for the image; determining the first set of parameters for the first area of the image; modifying the initial noise prediction corresponding to the first area based on the first set of parameters to generate a first modified noise prediction; determining the second set of parameters for the second area of the image; modifying the initial noise prediction corresponding to the second area based on the second set of parameters to generate a second modified noise prediction; combining the first modified noise prediction and the second modified noise prediction to form a composite noise prediction; and updating the latent representation based on the composite noise prediction.

In some embodiments, the denoising process may further include: determining whether further processing of the latent representation is required; and responsive to determining that further processing is required, repeating the denoising process on the latent representation. The denoising process may include, responsive to determining that further processing is not required, finishing the diffusion process on the latent.

In some embodiments, the method may further include repeating the denoising process over a series of timesteps, or for a predetermined period of time. In some embodiments, given a current timestep t, generating an initial noise prediction may include predicting the visual noise that would be present in the latent representation at a timestep t+1 during a noising process. The timestep t may be decremented after each iteration of the denoising process. The denoising process may be repeated between 15 and 40 times.

In some embodiments, the second set of parameters may be at least partially different to the first set of parameters. Each of the first set of parameters and the second set of parameters may include at least a guidance scale parameter and an image guidance scale parameter.

Determining a first set of parameters may include determining a first guidance scale parameter and a first image guidance scale parameter. Determining a second set of parameters may include determining a second guidance scale parameter and a second image guidance scale parameter having values which are different than the first guidance scale parameter and/or the first image guidance scale parameter.

In some embodiments, generating an initial noise prediction may include using the equation:

$$noise\_pred = ( noise\_pred \_uncond + guidance\_scale * ( noise\_pred \_text - noise\_pred \_image ) + image\_guidance \_scale * ( noise\_pred \_image - noise\_pred \_uncond ) )$$

wherein noise_pred_uncond represents noise without conditioning;
noise_pred_image represents noise conditioned by the image;
noise_pred_text represents noise condition by a text prompt;
guidance_scale represents a guidance scale parameter; and
image_guidance_scale represents an image guidance scale parameter.

In some embodiments, generating the first modified noise prediction or the second modified noise prediction may include using the equation:

$$noise\_pred \_modified = ( modified\_guidance \_scale * text\_guidance \_difference + modified\_image \_guidance \_scale * image\_guidance \_difference )$$

wherein modified_guidance_scale represents a modified guidance scale parameter;
modified_image_guidance_scale represents a modified image guidance scale parameter;

$$text\_guidance \_difference = noise\_pred \_image - noise\_pred \_uncond ; and$$

$$text\_guidance \_difference = noise\_pred \_text - noise\_pred \_image .$$

Combining the first modified noise prediction and the second modified noise prediction may include alpha blending the first modified noise prediction and the second modified noise prediction. In some embodiments, updating the latent representation based on the composite noise prediction may include subtracting the composite noise prediction from the latent representation to generate a new latent representation.

In some embodiments, the method may further include identifying a plurality of protected areas of the image. Determining a set of parameters for one or more protected areas of the plurality of protected areas may include using a blend of parameters determined for at least one other protected area and the at least one non-protected area.

Identifying the at least one protected area and the at least one non-protected area may include generating a segmentation map. The segmentation map may include a plurality of segments. Each segment of the plurality of segments may represent a segmentation mask.

In some embodiments, the denoising process may include: selecting a segment from the plurality of segments in the segmentation map; determining a set of parameters for the selected segment; generating a modified noise prediction for the selected segment; determining whether further segments exist; and responsive to further segments existing, selecting the next segment.

In some embodiments, modifying the initial noise prediction may include extrapolating the initial noise prediction based on the first set of parameters or the second set of parameters.

Some embodiments relate to a method for editing an image, the method comprising: accessing an image; identifying at least one protected area of the image and at least one non-protected area of the image; initialising a latent representation of the image; performing a denoising process on the latent representation, wherein the denoising process includes: generating an initial noise prediction for the image; determining a first set of parameters for the at least one protected area of the image; modifying the initial noise prediction corresponding to the protected area of the image based on the first set of parameters to generate a first modified noise prediction; determining a second set of parameters for the at least one non-protected area of the image; modifying the initial noise prediction corresponding to the non-protected area of the image based on the second set of parameters to generate a second modified noise prediction; combining the first modified noise prediction and the second modified noise prediction to form a composite noise prediction; updating the latent representation based on the composite noise prediction; and generating an edited image from the latent representation.

Some embodiments relate to a non-transitory computer-readable storage medium storing instructions which, when executed by a processing device, cause the processing device to perform any of the methods disclosed herein.

Some embodiments relate to a computing device comprising:
the non-transitory computer-readable storage medium disclose herein; and
a processor configured to execute the instructions stored in the non-transitory computer-readable storage medium.

### BRIEF DESCRIPTION OF DRAWINGS

Various ones of the appended drawings merely illustrate example embodiments of the present disclosure and cannot be considered as limiting its scope.

FIGS. 1A to 1C show a set of example images that illustrate the results of prompt-based image editing, according to some known methods;

FIGS. 2A to 2B show a further set of example images that show the results of prompt-based image editing, according to some known methods;

FIG. 3A is a process flow diagram of a method for editing an image, according to some embodiments;

FIG. 3B is a process flow diagram of a method for denoising, according to some embodiments;

FIG. 3C is a process flow diagram of a method of preserving image features during image editing, according to some embodiments;

FIGS. 4A and 4B show an example image to be edited and its corresponding segmentation map, according to some embodiments;

FIG. 5 is a process flow diagram of a denoising process loop, according to some embodiments;

FIG. 6 is a schematic diagram illustrating the denoising process to generate an edited image, according to some embodiments;

FIGS. 7A to 7D show a set of example images that illustrate the results of prompt-based image editing with and without the application of a method of preserving image features, according to some embodiments;

FIG. 8 is a block diagram of a system for performing prompt-based image editing with feature preservation, according to some embodiments; and

FIG. 9 is a process flow diagram of a method of performing prompt-based image editing with feature preservation, according to some embodiments.

### DESCRIPTION OF EMBODIMENTS

Described embodiments relate to systems, methods and computer program products for performing image editing. In particular, described embodiments relate to systems, methods and computer program products for preserving image features while performing automatic editing of digital images.

Prompt-based image editing refers to editing an image automatically based on an input prompt. Manual techniques to edit images can be time intensive and often require a high degree of skill to produce a result that looks convincing. Existing prompt-based image editing techniques can be used to perform some image editing processes, such as automatic inpainting processes that can be used for inserting or removing image elements. However, some prompt-based image editing techniques can produce an undesirable result. For example, some prompt-based image editing techniques may excessively edit certain image elements in an undesirable way.

This may be particularly true when the training data used to train the model performing the image editing is biased. This may occur where, given multiple image element types, the training data has many more examples of one or more particular characteristics being associated with a first image element than a second image element. For example, if the training data has many example images of a cat wearing a purple sweater and no examples of a dog wearing a purple sweater, then given an image of a dog and the prompt “make him wear a purple sweater”, the model may edit the image in such a way as to replace the dog with a cat.

This is particularly problematic where images of humans are being edited. Due to biases in training data, an image editing model may “learn” to associate certain visual features of humans with particular characteristics, such as particular professions. For example, the model may associate the profession “nurse” with traditionally feminine visual features such as long hair, make-up, and dresses. The model may associate the profession “doctor” with traditionally masculine visual features such as facial hair, short hair, and ties.

Some of the described embodiments provide an image editing technique that is capable of automatically editing images in a way that preserves certain image features to minimise the effects of biased training data. Specifically, some embodiments provide a prompt-based image editing technique that can control the strength of editing performed on image elements based on an image segmentation technique. Images containing people may be segmented in a way that allows for their skin, hair, clothing, or other features to be prescribed set image editing strength values that control the degree of editing that is performed on these different image element categories.

In the following description, the term “pixel information” as it relates to an image may comprise any information that is indicative of, associated with, derived/derivable from, comprised within and/or comprised of information that is indicative of the pixels that an image is comprised from. For example, pixel information may be Red, Green, Blue (RGB) values of subpixels that make up a single pixel. In some embodiments, pixel information may include a numerical representation and/or transformation of the RGB values of the subpixels, such as a latent mapping of the RGB values of the subpixels mapped onto a lower-dimensional latent space, for example. Pixel information may, in some embodiments, include any other type of information or representation of information that is indicative of the RGB values of a pixel and/or subpixels.

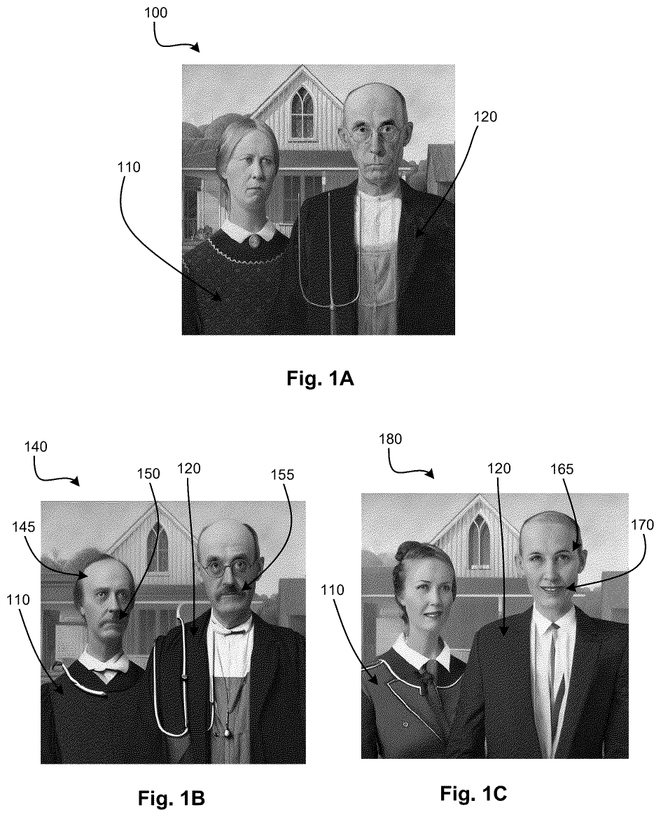

FIGS. 1A to 1C show examples of the results of some previously known prompt-based image editing techniques.

FIG. 1A shows an example original image 100 comprising two subjects, 110 and 120. Subject 110 is a female presenting subject wearing a dark shirt or dress with a white collar, a brown apron or pinafore with a white ric-rac trim, and having a brooch fastened at their neck. Subject 110 has long hair that has been parted at the centre and tied back, with a single loose tendril visible behind their ear. Subject 120 is a male presenting subject wearing a white shirt, denim overalls and a dark jacket. Subject 120 has a receding hairline, thick eyebrows, and is wearing glasses.

FIG. 1B shows an example edited image 140. Image 140 is an edited version of image 100 and has been generated using a prompt-based image editing technique performed by an image editing application according to some known techniques. For example, image 140 may have been generated using a diffusion machine learning (ML) model, which is a neural network model trained or otherwise configured to de-noise images containing Gaussian noise by learning to reverse the diffusion process. Image 140 may have been generated using the techniques as described in Brooks, T., Holynski, A. and Efros, A. A., 2023; “Instructpix2pix: Learning to follow image editing instructions”, published in Proceedings of the IEEE/CVF Conference on Computer Vision and Pattern Recognition (pp. 18392-18402) (“Brooks et al.”) the contents of which are herein incorporated by reference in their entirety.

Image 140 has been generated by supplying an appropriately trained ML model with the original image 100 and the text prompt “Make them look like doctors”. The result of the editing is that image 140 now has edited subjects 110 and 120. Subject 110 now has a short hairstyle 145 with a receding hairline, and a moustache 150. The brooch and ric-rac has been removed from the clothing of subject 110, which now appears more like a button-up shirt worn under a vest. In other words, subject 110 has been given a more masculine appearance. This indicates that most of the training data that was labelled as showing doctors contained male presenting subjects. The appearance of subject 120 has been less edited, but subject 120 has also had a moustache 155 added.

FIG. 1C shows another example edited image 180. Image 180 is also an edited version of image 100 and has been generated using a prompt-based image editing technique performed by an image editing application according to some known techniques. For example, image 180 may have been generated using a diffusion machine learning (ML) model, which is a neural network model trained or otherwise configured to de-noise images containing Gaussian noise by learning to reverse the diffusion process. Image 180 may have been generated using the techniques as described in Brooks et al.

Image 180 has been generated by supplying an appropriately trained ML model with the original image 100 and the text prompt “Make them look like flight attendants”. The result of the editing is that image 180 now has edited subjects 110 and 120. Subject 120 now has much thinner and more groomed eyebrows 165, and is wearing make-up including bright red lipstick 170. In other words, subject 120 has been given a more feminine appearance. This indicates that most of the training data that was labelled as showing flight attendants contained female presenting subjects. The appearance of subject 110 has been less edited, but subject 110 has also had bright red lipstick added, as well as a more feminine hairstyle.

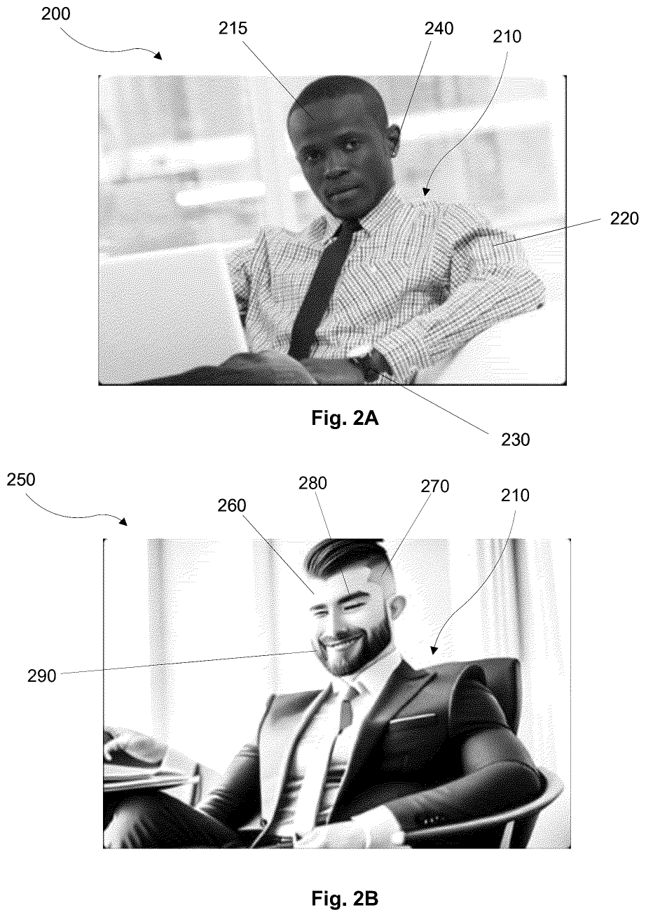

FIGS. 2A to 2B show an example of the results of some previously known prompt-based image editing techniques.

FIG. 2A shows an example original image 200 comprising a subject 210. The subject 210 is a male presenting subject wearing a light checkered business shirt 220 with a dark tie, a wristwatch 230 on their left hand, and an earring in their left ear 240. The subject 210 has a dark complexion 215, short hair and is relatively clean shaven. The subject 210 is shown positioned reclining in a chair, with a laptop in the foreground.

FIG. 2B shows an example edited image 250. Image 250 is an edited version of image 200, and has been generated using a prompt-based image editing technique performed by an image editing application according to some known techniques. For example, image 250 may have been generated using a diffusion ML model, which is a neural network model trained or otherwise configured to de-noise images containing Gaussian noise by learning to reverse the diffusion process. Image 250 may have been generated using the techniques as described in Brooks et al.

Image 250 has been generated by supplying an appropriately trained ML model with the original image 200 and the text prompt “Make me look like a CEO”. The result of the editing is that image 250 presents a fully edited subject 210 which bears almost no resemblance to subject 210 that appears in image 200, other than the positioning. Subject 210 now has a light complexion 260, long hair with a fade 270, groomed eyebrows 280, and a beard 290. In other words, subject 250 has been given the appearance of a stereotypical white male. This indicates that most of the training data that was labelled as showing CEOs contained subjects having a light or white complexion. As a result, the editing presented in image 250 has completely erased the race of the subject 210 from the provided image 200.

Such biases which appear in the edits shown in FIGS. 1A to 1C and FIGS. 2A to 2B present difficulties in image editing using diffusion ML models, which necessarily require training data that can inherently include biases.

Some embodiments of the present disclosure include methods for editing images, including generating an edited image in which at least a first area of the image is edited less than another area of the image. In some embodiments, methods and systems are provided which edit one or more areas of an image less than one or more other areas of the image.

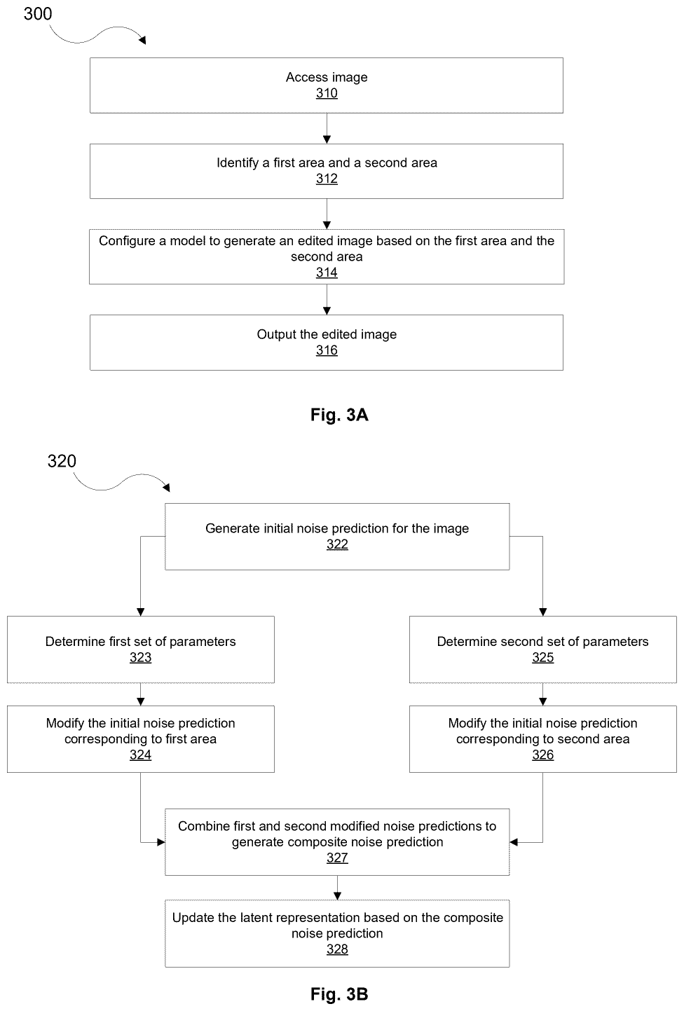

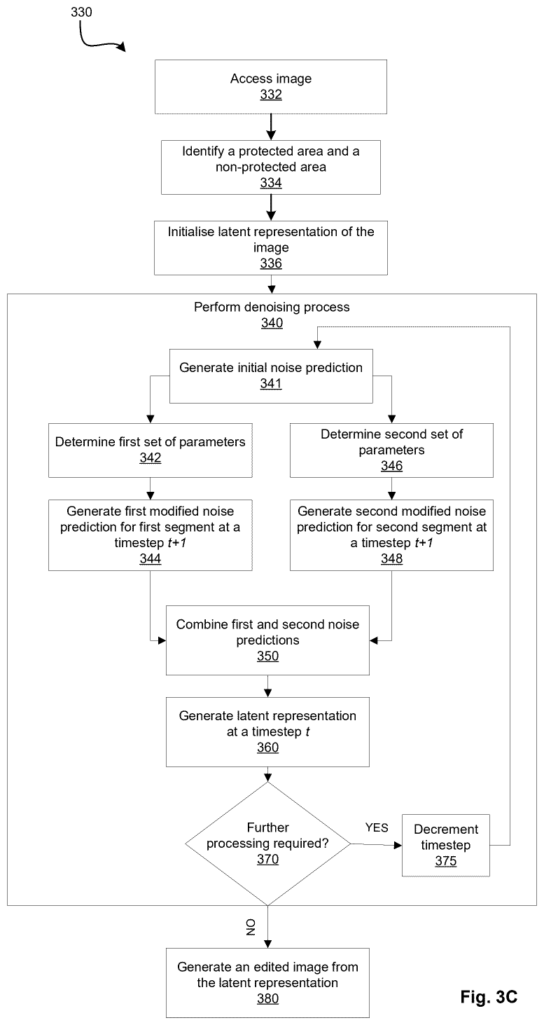

FIG. 3A is a process flow diagram of a method 300 for editing an image, according to some embodiments. The method 300, includes, at 310 accessing an image for editing. At 312, at least a first area and a second area of the accessed image are identified. In some embodiments, two or more areas of the accessed image may be identified in order to define a plurality of different areas within the accessed image. At 314, a model is configured to generate an edited image based on the first area and the second area of the accessed image. The edited image comprises a first area of the edited image and a second area of the edited image. The model is configured to generate the edited image such that the first area of the edited image differs from the first area of the accessed image less than the second area of the edited image differs from the second area of the accessed image. That is, the first area is edited less than the second area. At 316, the edited image is output.

In some embodiments, configuring the model to generate an edited image at 314 may include initialising a latent representation of the image, performing a denoising process on the latent representation, and generating an edited image from the latent representation. In some embodiments, configuring the model at 314 may include performing a denoising process on the accessed image. Initialising the latent representation may include converting the image from a pixel space to a latent space and applying random noise, for example, Gaussian noise. Generating an edited image from the latent representation may include converting the later representation back to the pixel space of the image.

FIG. 3B is a process flow diagram of a method 320 for denoising, according to some embodiments. The method 320 includes, at 322, generating an initial noise prediction for the image. At 323, a first set of parameters for the first area of the image is determined. The initial noise prediction corresponding to the first area is then modified based on the first set of parameters to generate a first modified noise prediction at 324. Before, after or at the same time as 323 and/or 324, a second set of parameters for the second area of the image is determined at 325. At 326, the initial noise prediction corresponding to the second area of the image is then modified based on the second set of parameters to generate a second modified noise prediction at 326. At 327, the first and second modified noise predictions are combined to form a composite noise prediction. At 328, the latent representation is updated based on the composite noise prediction. The method 320 may be repeated one or more times. The method 320 may be performed as part of 314 of method 300 disclosed herein.

Some embodiments of the present disclosure include methods for preserving image features during image editing, which allows for the reduction in biases of image editing. That is, in some embodiments, methods and systems are provided which protect or restrict segments of an image from being edited, or limit how and the degree to which segments of an image are edited by the diffusion ML model.

FIG. 3C is a process flow diagram of a method 330 of preserving image features during image editing, according to some embodiments. The method 330 includes, at 332, accessing an image for editing. At 334, at least one protected area and at least one non-protected area of the image to be edited are identified. Identifying the protected area and the non-protected area may be performed by generating a segmentation map. A segmentation map may include one or more segments which are designated as protected areas and/or non-protected areas of the image. The segmentation map may include a plurality of segments. A segmentation map of the image may be generated by using a segmentation model. The segmentation map may be referred to as a segmentation mask. The segmentation map may represent the at least one protected area and the at least one non-protected area. In some embodiments, the segmentation map of the image to be edited may be made up entirely of one or more protected areas.

In some embodiments, the segmentation map is used to control parameters for each pixel of the image, or the image's latent representation, individually.

In some embodiments, a protected area of the image to be edited may refer to an area, portion or segment of the image which should not be edited, or an area to which editing should be restricted or limited. A protected area of the image may refer to an area or portion of the image to which the weight of a prompt or the editing amount is limited or restricted, or to which different parameters and/or editing is applied. In some embodiments, a protected area may be continuous or non-continuous. The non-protected area of an image may indicate that the area has no restrictions or limitations placed on the editing of the area. The non-protected area of an image may correspond to any aspect or feature related to the subject, foreground and/or background of an image to be edited. The protected and/or the non-protected area of the image may be determined on the basis of a received prompt received to edit the image.

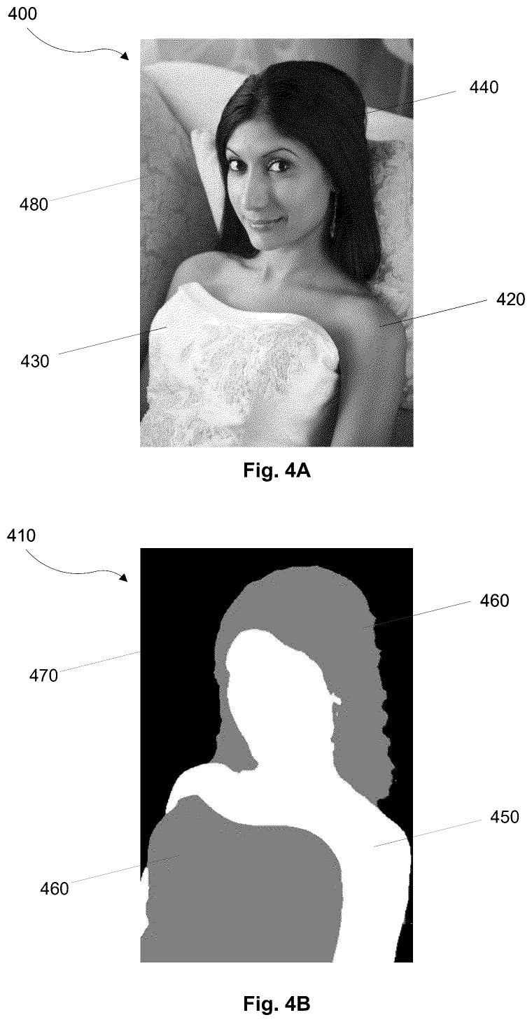

FIGS. 4A and 4B are illustrations of an image to be edited 400 and a corresponding segmentation map 410 which indicates the protected areas and the non-protected areas. In FIG. 4A, the image 400 includes a subject which has skin features 420, clothing features 430, and hair features 440. In FIG. 4B, the segmentation map 410 has been generated to identify two protected areas, a first protected area 450 which corresponds to the skin features 420, and a second protected area 460 which corresponds to clothing features 430 and hair features 440. The segment 470 of the segmentation map which corresponds to the background 480 of the image 400 represents a non-protected area.

The protected area of the image may correspond to a particular aspect or feature presented within the image. For example, a protected area may correspond to the features of an image which represent human features, such as skin, eyes, facial features, hair, shape, hands, expression, and the like. In another example, the protected area may correspond to the features of an image which are associated with a particular subject. For example, the protected area may correspond to clothes being worn by a subject. In some embodiments, the protected area may correspond to any aspect or feature related to the subject, foreground and/or background of an image to be edited.

In some embodiments, the method may include identifying a plurality of protected areas and/or non-protected areas. The at least one protected area and/or the at least one non-protected area of the image may be identified manually, for example such as being manually selected by a user indicating the area and/or features to be protected or not protected. In further embodiments, the protected area and/or the non-protected area of the image may be identified automatically. For example, the protected area and/or the non-protected area may be identified through the application of a recognition or detection algorithm. In some embodiments, identifying the protected area and the non-protected area of an image includes applying a detection algorithm to identify features within the image which relate to a specific categorisation and identifying these as protected or non-protected areas. In some embodiments, the protected area may be automatically identified for features of a subject that relate to a person such as skin, hair and/or clothing.

For example, the detection algorithm may detect “skin” and “person” features of the human subject in image 400, where “skin” features are identified as a first protected area 450, and “person” features are identified as a second protected area 460. As shown in the first protected area 450, the “skin” features may include the full face of the subject. The “person” features may include features such as hair, clothing, or anything that belongs to a human subject which is not “skin”. In some embodiments, the facial features including eyes, nose, mouth and the like may or may not be considered as separate features to “skin” features.

Referring back to FIG. 3C, at 336, a latent representation of image is initialised. Initialising the latent representation of the image may include generating an embedding of the image, and applying a random sampled noise (or a randomly generated signal noise, for example Gaussian noise) to the image embedding. In some embodiments, the image embedding is generated through an encoder. Generating the image embedding may include generating a latent mapping of the pixel information of the image, for example, the image may be compressed into the latent space. The latent representation may be referred to as the latent of the image, or the latent mapping of the image.

The latent representation may include randomly generated signal noise, for example Gaussian noise. In some embodiments, this may be applied in such a way to add a certain level, degree or amount of visual noise to the latent representation of the image. In some embodiments, randomly generated signal noise may be applied to the pixel information of a supplied image before the latent is generated. The amount of generated signal noise added to the latent representation may be based on a noise strength parameter.

After initialising the latent representation, the method 330 further includes performing a denoising process on the latent representation at 340.

In some embodiments, all or part of the denoising process may be performed using a U-net. The U-net is a fully convolutional neural network and consists of a contracting path and an expansive path. The contracting path is a typical convolutional network that consists of repeated application of convolutions, each followed by a rectified linear unit (ReLU) and a max pooling operation. During the contraction, the spatial information is reduced while feature information is increased. The expansive pathway combines the feature and spatial information through a sequence of up-convolutions and concatenations with high-resolution features from the contracting path. In other words, an image is converted into a vector, but is then converted back from that vector into an image.

The denoising process may comprise inferring, by the U-net from generated visual noise, an initial noise prediction of an image to be generated, based on the initial visual noise and a representation of a prompt. The initial noise prediction may then be subtracted from the initial visual noise to generate a subsequent visual noise, which will then be fed back into the U-net, along with the representation of the prompt, to generate a subsequent noise prediction of the image to be generated. This process may be repeated iteratively until one or more termination criteria is met, such as a decrementing timestep counter reaching zero, or a predetermined amount of time elapsing, for example.

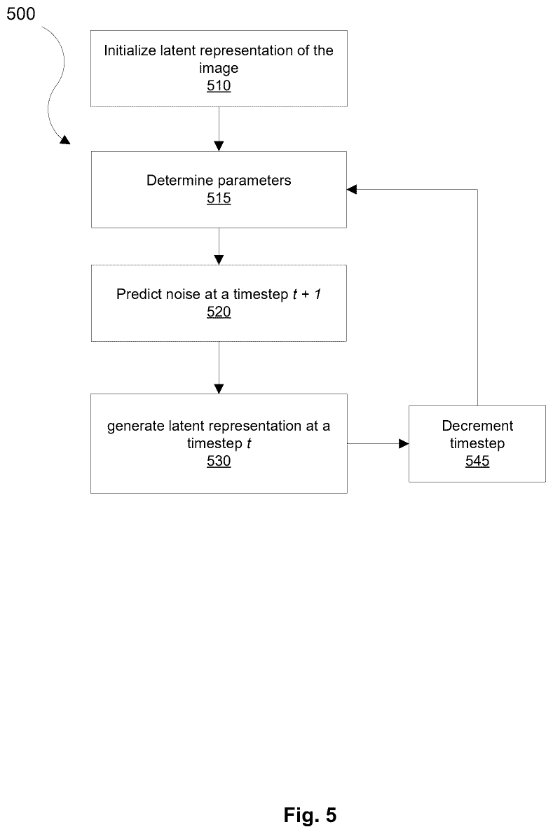

FIG. 5 is a process flow diagram of a denoising process loop 500, in which a backwards diffusion process is used to transform a latent representation into an edited image based on a received prompt through a series of noise predictions generated by a ML model. Each pass through the loop comprises a timestep in the denoising process, which is considered a backwards step in reference to a time t. The denoising is a backwards or reverse diffusion process compared to a forwards noising process that is performed during training of the ML model.

The ML model may be an ML model trained using the techniques as described in Brooks et al. The ML model may use a prompt representation as generated by an encoding module to guide the denoising process. Specifically, the ML model may use the prompt representation to manipulate an image representation containing visual noise in a way that causes the noise to be transformed into an image corresponding to the prompt representation. In some embodiments, the ML model may be a latent diffusion ML model, which is a diffusion ML model configured to perform the denoising process on a mapping of the image to a lower-dimensional latent space, as described below with reference to latent module 839. According to some embodiments, the ML model may be a stable diffusion ML model.

In some embodiments, the ML model may be a pre-trained and commercially available, open-use or open-source ML model, such as, for example, Open AI's DALL-E/DALL-E 2, Google's Imagen and/or Comp Vis' Stable Diffusion.

Immediately prior to the start of the denoising loop can be considered as a timestep t+1, where the latent representation at timestep t+/is the visual noise generated when the latent representation of the image is initialised. As the denoising loop is a reverse process, each iteration of the loop concludes with the timestep moving backwards, so that t=t−1, and the amount of noise is reduced. That is, adding to the timestep results in increased noise as noise is added to the latent representation, while reducing the timestep results in decreased noise as noise is subtracted from the latent representation. The start of the denoising loop therefore occurs at a timestep t.

Before the denoising loop 500 starts, at 510, the latent representation of the image is initialised. The denoising loop then starts at 515, in which parameters which affect the noise prediction are determined. The parameters may be manually input or retrieved. For example, the parameters may include parameters that determine how much weighting should be provided to the input prompt versus the input image, in order to determine the noise prediction.

At 520, noise that would have been added to the current latent representation during a timestep t+1 is predicted. The noise prediction represents the noise that would have been added were a noising process have been carried out on an edited image, as described by the received prompt, to generate the current latent representation. The noise prediction is performed by providing the latent representation, an area to be edited (in this case, an identified protected and non-protected area (for example, by way of a segmentation map)), and a provided prompt to a ML model trained to perform a denoising process, such as the ML model described in Brooks et al.

At 530, the latent representation for a current timestep t is generated. This may also be referred to as updating the current state of the latent representation. This is generated based on the noise predicted at 520 and the latent representation at timestep t+1. In some embodiments, the latent at timestep t is generated by subtracting the noise calculated at 520 from the latent at timestep t+1. The latent at timestep t is therefore less noisy than the latent at timestep t+1. If there is further processing to be performed on the latent representation, then timestep t is decremented by one at 545, and the process returns to the start of the loop in determining parameters for the noise prediction at 515. The denoising process loop 500 is repeated until no further processing of the latent representation is required.

Referring back to FIG. 3C, the denoising loop 500 is performed at 340 of the method 330. At 340, the denoising loop is performed to generate a first modified noise prediction and a second modified noise prediction, both at timestep t+1, for each of the protected area and the non-protected area of the image, and then combines the noise predictions at 350 to generate the latent representation at a timestep t.

The denoising process at 340 includes generating an initial noise prediction (341), determining a first set of parameters for the protected area of the image (342), and generating a first modified noise prediction corresponding to the protected area of the image based on the first set of parameters (344). The denoising process further includes determining a second set of parameters for the non-protected area of the image (346) and generating a second modified noise prediction corresponding to the non-protected area of the image based on the second set of parameters (348). In some embodiments, the denoising process may involve performing 342 and then 344 before or after performing 346 and then 348. In other embodiments, the denoising process may involve performing 342 and then 344 at the same time as performing 346 and then 348.

In some embodiments, the initial noise prediction generated at 341 is a noisy representation of the entire input image. In other embodiments, the initial noise prediction generated at 341 is a noisy representation of both the protected area and the non-protected area. The initial noise prediction may be generated based on the current timestep in the denoising loop, being timestep t. The initial noise prediction may be computed by adding random noise to the protected area and the non-protected area.

In some embodiments, the modified noise predictions generated at 344 and 348 are noisy representations of the protected area and the non-protected area, which may be generated based on the current timestep in the denoising loop, being timestep t. The modified noise prediction may be computed by extrapolating the initial noise prediction vector, for example, by multiplying it based on parameters to change its direction and length. The strength and direction of the extrapolation and/or modification from the initial noise prediction for each of the areas is controlled by a set of parameters, and is dependent on the current timestep t. The set of parameters control how, and the extent to which, the initial noise prediction is modified to generate the modified noise predictions. As such, the parameters are mechanisms which affect the results of each iteration of the denoising process. In some embodiments, the modification of the initial noise prediction may be considered a post-processing of the initial noise prediction.

The determining of the first and second set of parameters at 342 and 346 may be performed in sequence or in parallel. In some embodiments, the set of parameters may include parameters which determine the weight given to the prompt, and/or which determine the strength of the editing applied to the image. In some embodiments, the parameters may include guidance scale (or “guidance_scale”), which represents the magnitude of the classifier free guidance during the denoising process. The guidance scale parameter controls how much of an influence the prompt has on the result of the editing. The parameters may further include image guidance scale (or “image_guidance_scale”) which controls how much of an influence the original image has on the result. That is, it works inversely compared to the guidance scale parameter. The higher the image guidance scale is, the less the image will be modified by the edit. In some embodiments, the first set of parameters and the second set of parameters include guidance scale and image guidance scale parameters. The second set of parameters may be different to, or the same as, the first set of parameters. In some embodiments, where there are a plurality of protected areas and non-protected areas, each protected area may have a unique set of parameters, and each non-protected area may have a unique set of parameters.

The initial noise may be predicted without conditioning on a prompt, for example, the initial noise prediction may be unconditional. This may be referred to herein as noise_pred_uncond. Alternatively, the initial noise may be predicted being conditioned on a prompt (or prompt embedding(s)) such as a text prompt. That is, the initial noise prediction may be conditional. This may be referred to as noise_pred_text, although it will be appreciated that the prompt may vary in format and is not limited to a text prompt. A classifier free guidance (CFG) mechanism may be used to modify the predicted initial noise to weight the edit more heavily in the direction of the noise_pred_text, that is, the conditioning of the prompt. This weighting is scaled by the guidance scale parameter. In some embodiments, the predicted initial noise may be modified to favour the prompt using the following formula:

$$noise\_pred = noise\_pred \_uncond + guidance\_scale * ( noise\_pred \_text - noise\_pred \_uncond )$$

That is, the difference between the prompt-conditioned noise and unconditional noise is calculated and then the final result is modified to go more in the direction of the text-conditional noise than the U-net would have predicted. This enables the determination of how much the denoising process pushes or guides the final result of the edited image into the direction of what the prompt describes.

In some embodiments, initial noise may be predicted being conditioned or guided by the input image, that is, the image to be edited. This may be referred to herein as noise_pred_image. The classifier free guidance mechanism may be used to modify the predicted initial noise to weight the edit more heavily in the direction of the noise_pred_image, that is, the final edit will have more similarity to the input image which is being edited. This weighting is scaled by the image guidance scale parameter. In some embodiments, the formula for initial noise prediction may be modified to include weighting of the input image using the following formula:

$$noise\_pred = ( noise\_pred \_uncond + guidance\_scale * ( noise\_pred \_text - noise\_pred \_image ) + image\_guidance \_scale * ( noise\_pred \_image - noise\_pred \_uncond ) )$$

In some embodiments, the total noise prediction may be influenced in two different directions, towards the text prompt or towards the input image. These directions are scaled by the guidance scale and the image guidance scale, respectively. In some embodiments, the directions may be computed as direction vectors, as follows:

$$image\_guidance \_difference = noise\_pred \_image - noise\_pred \_uncond$$

$$text\_guidance \_difference = noise\_pred \_text - noise\_pred \_image$$

In some embodiments, the first modified noise prediction may be generated by modifying the initial noise prediction in accordance with a first set of parameters. That is, by using the above formula for noise_pred and then multiplying or extrapolating the initial noise prediction vector based on a first set of parameters. The first set of parameters may include an image guidance scale parameter and a guidance scale parameter. For example, the first modified noise prediction may be generated using the formula:

$$noise\_pred \_first = ( first\_guidance \_scale * text\_guidance \_difference + first\_image \_guidance \_scale * image\_guidance \_difference )$$

The second modified noise prediction may be generated by modifying the initial noise prediction in accordance with a second set of parameters. That is, by using the above formular for noise_pred and then multiplying or extrapolating the initial noise prediction vector based on a second set of parameters. The second set of parameters may include an image guidance scale parameter and a guidance scale parameter. For example, the second modified noise prediction may be generated using the formula:

$$noise\_pred \_second = ( second\_guidance \_scale * text\_guidance \_difference + second\_image \_guidance \_scale * image\_guidance \_difference )$$

The first set of parameters and the second set of parameters may each include different or the same values for the image guidance scale parameter and the guidance scale parameter. For example, in the first set of parameters, each of the image guidance scale parameter and the guidance scale parameter may be higher or lower than each of the image guidance scale parameter and the guidance scale parameter in the second set of parameters. In some embodiments, the difference between the value of the image guidance scale parameter and the value of the guidance scale parameter may determine whether the parameters are considered more or less conservative. In some embodiments, the first modified noise prediction may be generated on the basis of more conservative parameters, and the second modified noise prediction may be generated on the basis of less conservative parameters.

After the first modified noise prediction and the second modified noise prediction have been generated at 344 and 348, the method 330 includes combining the first modified noise prediction and the second modified noise prediction to form a composite noise prediction at 350. Combining the first modified noise prediction and the second modified noise prediction to form a composite noise prediction may include combining the generated modified noise predictions with the latent representation using the masks of the protected area and the non-protected area of the image. Combining the first modified noise prediction at a timestep t+1 and a second modified noise prediction at a timestep t+1 may form a composite noise prediction at timestep t+1. Combining the first modified noise prediction and the second modified noise prediction may include blending the first modified noise prediction and the second modified noise prediction. For example, the first modified noise prediction and the second modified noise prediction may be combined using alpha blending (a-blending).

The alpha blending may be performed based on the following equation:

$$composite\_noise \_pred = noise\_pred \_uncond + noise\_pred \_first * first\_mask + noise\_pred \_second * ( 1 - first\_mask )$$

wherein composite noise pred represents the composite noise prediction generated by combining the first modified noise prediction and the second modified noise prediction, and first_mask represents the segment or mask related to the protected area corresponding to the first modified noise prediction.

The composite noise prediction is then used to generate the latent representation at a timestep t at 360. Generating the latent representation at timestep t may include updating the current state of the latent representation, for example, by subtracting the composite noise prediction at a timestep t+1 from the latent representation at current timestep t. This enables the editing of the protected area of the image and the non-protected area of the image to be controlled using different parameters, for example, different weightings of the image guidance scale and the guidance scale. For example, it enables particular features which are encompassed in the protected area to be more protected from editing, that is, preserved than the features which are encompassed by the non-protected area.

At 370, the method further includes determining whether further processing of the latent representation is required. Responsive to determining that further processing is required, the denoising process is repeated, with the timestep being decremented at 375, and then reverting back to generating an initial noise prediction at 341. In some embodiments, further processing may be determined by comparing the number of denoising cycles that have been performed with a predetermined number of denoising cycles that are to be performed. For example, where the number of denoising cycles that have been performed is less than the number of denoising cycles that are to be performed, then it may be determined that further processing is required. In some embodiments, the predetermined number of denoising cycles to be performed is between 15 and 40 denoising cycles may be performed. In some embodiments, between 20 and 30 denoising cycles may be performed. For example, around 20, 25 or 30 denoising cycles may be performed. In further embodiments, further processing may be determined by comparing a time elapsed from the start of the first denoising process with a predetermined amount of time over which the denoising cycle is to be performed. For example, where the time elapsed from the start of the first denoising process is less than the predetermined amount of time over which the denoising cycle is to be performed, then it is determined that further processing is required. In yet further embodiments, further processing is determined to be required when a timer or step counter has not reached zero.

If it is determined that no further processing is required at 370, then an edited image is generated from the latent representation at 380. Generating the edited image from the latent representation may include converting the latent representation back into the pixel space.

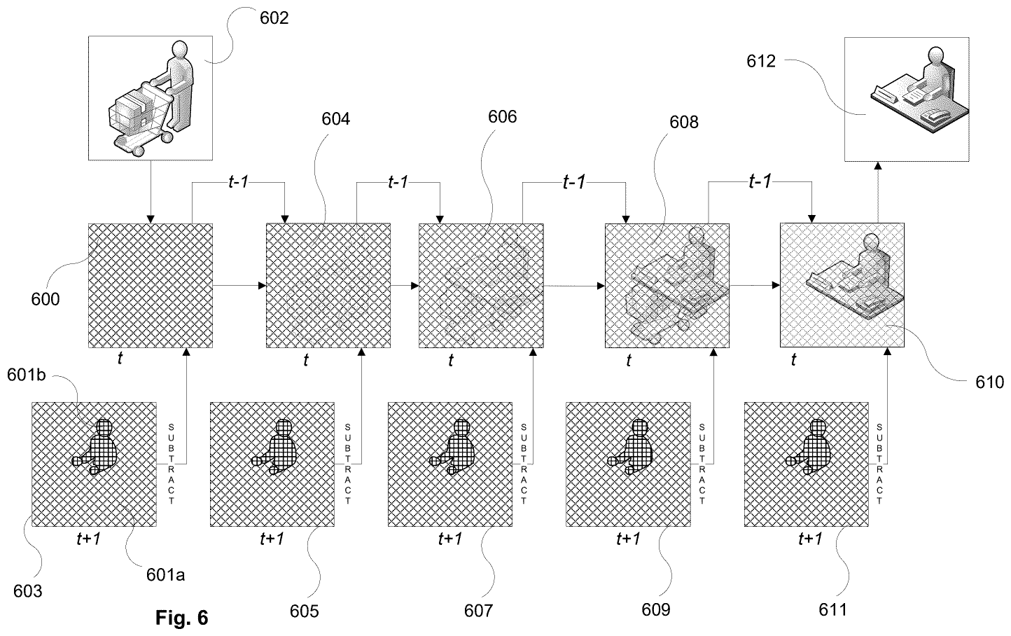

FIG. 6 is a schematic diagram illustrating the process by which a composite noise prediction is used to generate the latent representation at timestep t and result in an edited image. A latent representation 600 is generated from an input image 602, which is an image to be edited in line with a received prompt. In FIG. 6, the prompt may be “Make me a CEO”. A composite noise prediction 603 for timestep t+1 is generated. The composite noise prediction 603 is made up a modified noise prediction for a first segment 601a and a modified noise prediction for a second segment 601b. The composite noise prediction is then subtracted from the latent representation 600 to generate a new latent representation 604 as the latent representation for timestep t. The modified noise prediction for the first segment 601a has been generated with different parameters to the modified noise prediction for the second segment 601b. Accordingly, when the composite noise prediction is used to generate the latent representation 604, the modified noise prediction of the first segment 601a is being generated in such a way to protect or preserve more of the original image 602.

Where further processing is required, the timestep t is decremented by 1, and a composite noise prediction 605 for timestep t+1 is generated, and again subtracted from the current latent representation 604, to generate a new latent representation 606 at timestep t. This process is repeated in accordance with methods of the denoising process disclosed herein for a predefined number of sampling steps, removing the noise from each newly generated latent representation by subtracting the composite noise prediction to eventually reveal an edited image 612 from the noise when the predefined number of sampling steps reaches zero.

Some embodiments disclosed herein may provide technical advantages and improvements in the fields of image editing and image processing. The steps performed during the denoising process enhance the image editing process by protecting features of the image from being edited too heavily towards the prompt, thereby reducing the bias which may exist within training data. It enables features of the image, such as skin, hair and clothes to be retained or preserved while still allowing the image to be edited in accordance with the prompt. Specifically, the steps are configured to control any edits to the protected areas of the image, without affecting the unprotected areas of the image. This improves the control over editing of each pixel in the image, avoiding too much editing of specific aspects of an image in line with a received prompt. By controlling different segments of the image separately, the generated image may be improved as more specific edits to an image are enabled. It also provides a mechanism to reduce bias which may appear in the image edits, such as changing skin colour, gender presentation, or introducing stereotypical features.

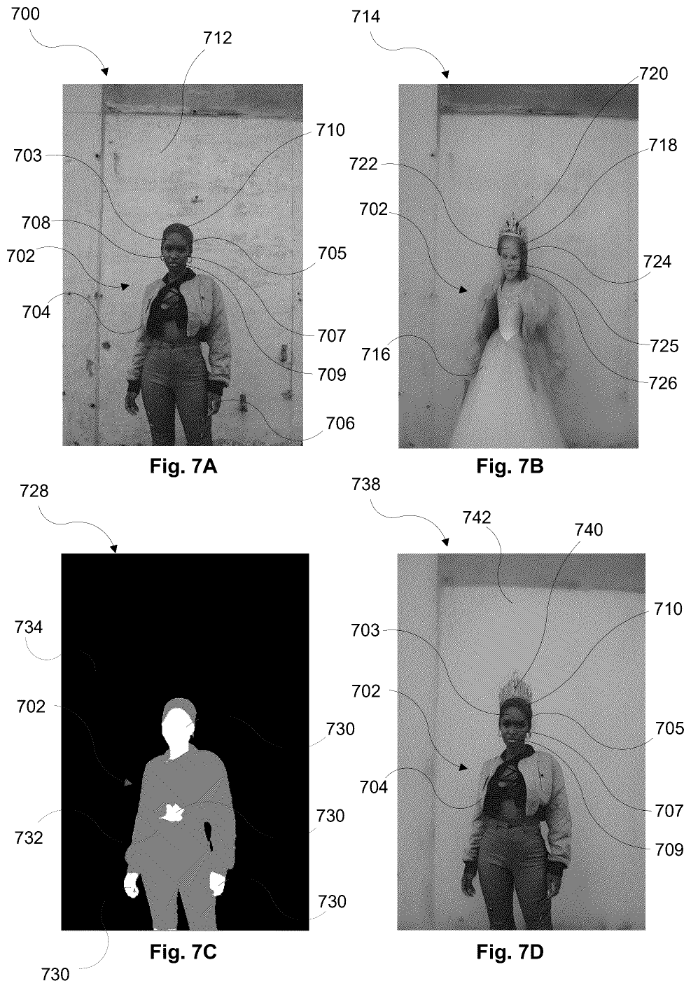

FIGS. 7A to 7B show examples of the results of applying the method 330 to an image 700.

FIG. 7A shows an example original image 700 comprising a subject 702. Subject 702 is a female presenting subject having a dark complexion 703, and facial features including dark eyes 705, broad nose 707 and thick, dark lips 709. The subject 702 is wearing clothes 704 including a cropped top, a light jacket and dark pants. The subject 702 has painted nails 706 and is wearing hoop earrings 708. The subject 702 has short dark hair 710. The background 712 of original image 700 presents a concrete wall with paint chips, metal brackets, holes, and other derelict features.

FIG. 7B shows an example of an edited image 714. Image 714 is an edited version of image 700, which has been generated using a prompt-based image editing technique performed by an image editing application without any image or feature protection applied to the editing. Image 714 has been generated by supplying an appropriately trained ML model with the original image 700 and the text prompt “make me a princess”. The result of the editing is that image 714 has almost entirely edited the appearance of subject 702. Subject 702 has had clothes 704 replaced with a pink princess gown 716. The subject's hair 710 has been replaced with longer smooth light-coloured hair 718 with a tiara 720 on top of the head. Most notable, the subject's face has been entirely changed, replacing the subject's face and neck complexion 703 with a light complexion 722, replacing the subject's dark eyes 705 with light eyes 724, replacing the subject's nose 707 with a thinner nose 725, and replacing the subject's lips 709 with thin, lighter lips 726. That is, the race of the subject 702 appears to have been erased in favour of biased features.

Method 330 may be applied to the original image 700 to provide an image edit which preserves identified features in the original image 700, effectively protecting them from being changed too much in favour of the prompt.

Image 700 is accessed, and then protected areas and non-protected areas are identified. FIG. 7C illustrates an example segmentation map 728 of the protected areas and the non-protected areas. In mask 728, there are two protected areas: a first protected area 730 representing the skin of the subject 702, and a second protected area 732 representing the clothes of the subject 702. The unprotected area 734 represents all other areas of the image.

A latent representation of the image 700 is initialised, and a denoising process is performed. During the denoising process, an initial noise prediction is generated for the original input image 700, for example, by a U-net. Then, a set of parameters is determined for each of the protected areas 730, 732 and the non-protected area 734. For each segment or area defined by the segmentation map 728 a modified noise prediction is generated from the initial noise prediction. In some embodiments, the modified noise prediction may be generated, for example, with conservative parameters for the protected area 730 and less conservative parameters for the non-protected area 734. For example, for area 730, the image guidance scale parameter may have a value of 3.0, and the guidance scale parameter may have a value of 3.0, allowing the area 730 to be modified less. For area 734, the image guidance scale parameter may have a value between 0.5 and 2.0, and a guidance scale parameter may have a value of 7.5, allowing the area 734 to be edited more. It will be appreciated that these parameters can be varied to modify the initial noise predictions in various ways and thereby generate results with different editing strengths. For area 732, a combination of the parameters used in protected area 730 and non-protected area 734 may be used. The noise prediction for each of the areas 730, 732, 734 are combined to form a composite noise prediction. The composite noise prediction is then used to generate a new latent representation. A plurality of sampling steps may be used to loop through a number of iterations of the denoising process until the latent representation is converted back to an edited image in the pixel space.

FIG. 7D shows an example edited image 738. Image 738 is an edited version of image 700, which has been generated using method 330. Image 738 has been generated by applying method 330 with the original image 700 and the text prompt “make me a princess” as inputs. The result of the editing is that the method 330 has protection areas of the original image 700 to prevent them from being edited too heavily. In contrast to edited image 714, image 738 has maintained the general appearance of the subject 702 which were included in protected areas 730 and 732. In particular, the subject's complexion 703, facial features 705, 707, 709, and clothes 704 are substantially consistent with original image 700. The edited image 738, however, does include some changes consistent with the text prompt. For example, the hair 710 of the subject 702, has been smoothed, almost giving the appearance of an updo, without changing the colour or length of the hair. Additionally, the subject 702 has a tiara 740 placed on top of the head. The background 712 has been smoothed to remove the derelict features, now presenting a background of a smooth white wall 742.

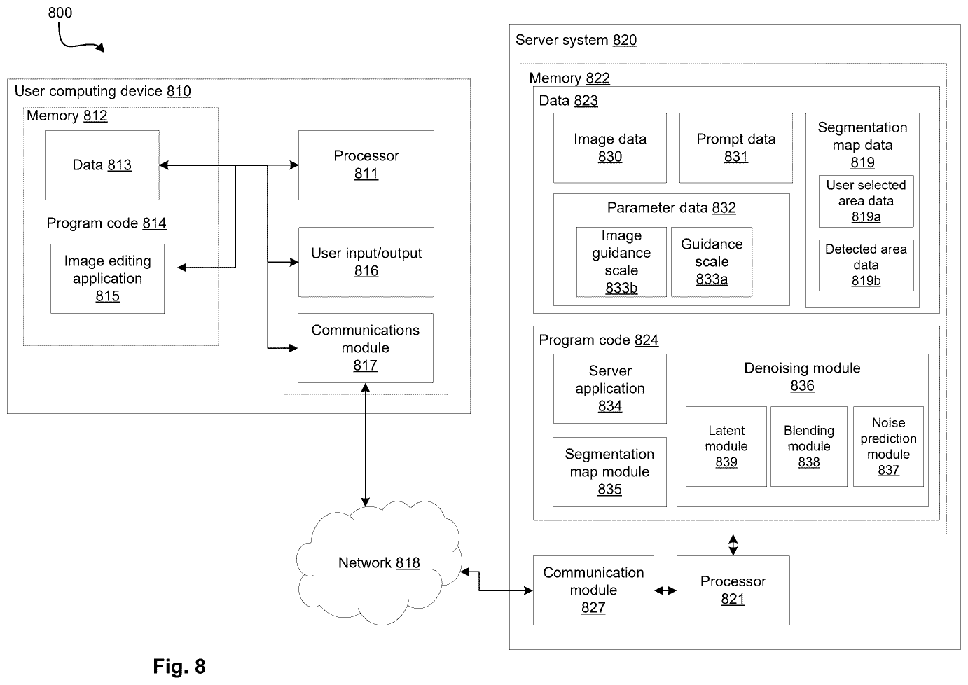

FIG. 8 shows an arrangement of system components, including hardware and software of systems that may be used to perform the presently disclosed methods. FIG. 8 is one embodiment of a number of potential embodiments that would be suitable for performing the present methods, including methods 300, 320, 330, 500 and 900 disclosed herein.

FIG. 8 is a block diagram showing an example system 800 that may be used for preserving features during image editing according to some described embodiments. System 800 comprises a user computing device 810 which may be controlled by a user wishing to edit one or more images. In the illustrated embodiment, system 800 further comprises a server system 820. User computing device 810 may be in communication with server system 820 via a network 818. However, in some embodiments, user computing device 810 may be configured to perform the described methods independently, without access to a network 818 or server system 820.

User computing device 810 may be a computing device such as a personal computer, laptop computer, desktop computer, tablet, or smart phone, for example. User computing device 810 comprises a processor 811 configured to read and execute program code. Processor 811 may include one or more data processors for executing instructions, and may include one or more of a microprocessor, microcontroller-based platform, a suitable integrated circuit, and one or more application-specific integrated circuits (ASICs).

User computing device 810 further comprises at least one memory 812. Memory 812 may include one or more memory storage locations which may include volatile and non-volatile memory, and may be in the form of ROM, RAM, flash or other memory types. Memory 812 may also comprise system memory, such as a BIOS.

Memory 812 is arranged to be accessible to processor 811, and to store data that can be read and written to by processor 811. Memory 812 may also contain program code 814 that is executable by processor 811, to cause processor 811 to perform various functions. For example, program code 814 may include an image editing application 815. Processor 811 executing image editing application 815 may be caused to perform the image editing methods disclosed herein.

According to some embodiments, image editing application 815 may be a web browser application (such as Chrome, Safari, Internet Explorer, Edge, Opera, or any other alternative web browser application) which may be configured to access web pages that provide image editing functionality via an appropriate uniform resource locator (URL).

Program code 814 may include additional applications that are not illustrated in FIG. 8, such as an operating system application, which may be a mobile operating system if user computing device 810 is a mobile device, a desktop operating system if user computing device 810 is a desktop device, or an alternative operating system.

User computing device 810 may further comprise user input and output peripherals 816. These may include one or more of a display screen, touch screen display, mouse, keyboard, speaker, microphone, and camera, for example. User I/O 816 may be used to receive data and instructions from a user, and to communicate information to a user.

User computing device 810 may further comprise a communications module 817, to facilitate communication between user computing device 810 and other remote or external devices. Communications module 817 may allow for wired or wireless communication between user computing device 810 and external devices, and may use Wi-Fi, USB, Bluetooth, or other communications protocols. According to some embodiments, communications module 817 may facilitate communication between user computing device 810 and server system 820 via a network 818, for example.

Network 818 may comprise one or more local area networks or wide area networks that facilitate communication between elements of system 800. For example, according to some embodiments, network 818 may be the internet. However, network 818 may comprise at least a portion of any one or more networks having one or more nodes that transmit, receive, forward, generate, buffer, store, route, switch, process, or a combination thereof, etc. one or more messages, packets, signals, some combination thereof, or so forth. Network 818 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, or some combination thereof.

Server system 820 may comprise one or more computing devices and/or server devices (not shown), such as one or more servers, databases, and/or processing devices in communication over a network, with the computing devices hosting one or more application programs, libraries, APIs or other software elements. The components of server system 820 may provide server-side functionality to one or more client applications, such as image editing application 815. The server-side functionality may include operations such as user account management, login, and content creation functions such as image editing, saving, publishing, and sharing functions. According to some embodiments, server system 820 may comprise a cloud-based server system. While a single server system 820 is shown, server system 820 may comprise multiple systems of servers, databases, and/or processing devices. Server system 820 may host one or more components of a platform for performing image editing according to some described embodiments.

Server system 820 may comprise at least one processor 821 and a memory 822. Processor 821 may include one or more data processors for executing instructions, and may include one or more of a microprocessor, microcontroller-based platform, a suitable integrated circuit, and one or more application-specific integrated circuits (ASIC's). Memory 822 may include one or more memory storage locations, and may be in the form of ROM, RAM, flash or other memory types.

Memory 822 is arranged to be accessible to processor 821, and to contain data 823 that processor 821 is configured to read and write to. Data 823 may store data such as user account data, image data, and data relating to image editing tools, such as machine learning models trained to perform image editing functions.

In the illustrated embodiment, data 823 comprises image data 830, prompt data 831, parameter data 832 and segmentation map data 819. Parameter data 832 may include guidance scale parameters 833a and image guidance scale parameters 833b. While these are illustrated as residing in memory 822 of server system 820, in some embodiments some or all of this data may alternatively or additionally reside in memory 812 of user computing device 810, or in an alternative local or remote memory location.

Image data 830 may store image data relating to an image to be edited by image editing application 815. Image data 830 may be received from user computing device 810 executing image editing application 815 in response to a user selecting or uploading an image to be edited. For example, referring to the examples shown in FIGS. 4A and 7A, images 400 and/or 700 may be stored in image data 830. Image data 830 may additionally or alternatively store image data relating to images that are in the process of being edited.

Prompt data 831 may be received from user computing device 810 in response to a user entering a prompt while executing image editing application 815, in order to perform an image editing function. For example, in the example illustrated in FIG. 7A, the user has entered the prompt “Make me a princess”. Prompts may be stored in prompt data 831 as a string of text.

Segmentation map data 819 may be received from user computing device 810 in response to a user selecting an area of an image while executing image editing application 815, for example, in order to protect or preserve that area during image editing. According to some embodiments, a user wishing to edit an image may interact with user I/O 816 of user computing device 810 displaying the image to indicate which area of the image they wish to protect. For example, the user may use a brush tool, trace tool, or other tool to digitally select, trace, circle, or “paint” over the image element to be protected via the user interface to produce a user selected area, which can be used to generate the segmentation map to protect a feature during image editing method as described in further detail below. The user selected area may be stored as user selected area data 819a within the segmentation map data 819. In some cases, the segmentation map data 819 may include image data representing one or more masks defined by the user selected area data 819a. For example, a binary mask may be generated, where a first pixel value may represent areas of the image falling within the user selected area and a second pixel value different to the first pixel value may be used to represent areas falling outside of the user selected area. In some embodiments, white pixels may represent the user selected area, being the area selected for editing, and black pixels may represent areas outside the user selected area where no features are to be protected or preserved during image editing.

Segmentation map data 819 may be received automatically, for example, from a detection algorithm. A detection algorithm may be executed by the segmentation map module 835 on the input image. In some embodiments, a user may input, through an image editing application 815, one or more specific feature to be detected by the detection algorithm within the image such as, for example, “skin”, “hair” or “person”. In response to receiving an input from a user, the detection algorithm will identify areas in the image which may be classified as corresponding to the inputs. The detection algorithm may identify one or more areas of the image as detected areas which correspond to one or more protected areas to be protected or preserved during image editing. The detected area may be stored as detected area data 819b within the segmentation map data 819. In some cases, the segmentation map data may include image data representing a mask defined by the detected area 819b. For example, a binary mask may be generated, where a first pixel value may represent areas of the image falling within the detected area and a second pixel value different to the first pixel value may be used to represent areas falling outside of the detected area. In some embodiments, white pixels may represent the detected area, being the area selected for preservation, and black pixels may represent areas outside the detected area where no features are to be protected or preserved during image editing.

Memory 822 further comprises program code 824 that is executable by processor 821, to cause processor 821 to execute workflows. For example, program code 824 comprises a server application 834 executable by processor 821 to cause server system 820 to perform server-side functions. According to some embodiments, such as where image editing application 815 is a web browser, server application 834 may comprise a web server such as Apache, IIS, NGINX, GWS, or an alternative web server. In some embodiments, the server application 834 may comprise an application server configured specifically to interact with image editing application 815. Server system 820 may be provided with both web server and application server modules.

Program code 824 may also comprise one or more code modules, such as one or more of a segmentation map module 835, a denoising module 836, a noise prediction module 837, an alpha blending module 838, and a latent module 839. The noise prediction module 837, alpha blending module 838 and latent module 839 may form part of the denoising module 836. The program code may further comprise an encoding module (not shown), a cropping module (not shown), a resolution adjustment module (not shown) and a visual noise module (not shown).

Executing segmentation map module 835 may cause processor 821 to perform a segmentation map generation process on an image to be edited. According to some embodiments, processor 821 executing segmentation map module 835 may be caused to generate a segmentation map which includes one or more segments, or areas, with each segment representing an object or a specific area on the image. The segmentation map may be generated based on user input, such as a user selected area, or it may be generated by execution of a detection algorithm. In some embodiments, a detection algorithm is used to classify areas of the image and map each area to a specific segment. For example, the detection algorithm may be configured to classify “person” areas of the image, such as “skin”, “hair” or “clothing”, and may use these areas to generate one or more segments to form a segmentation map. The segmentation map module 835 may execute the generation of a segmentation map having one or more protected areas and one or more non-protected areas.

Executing encoding module may cause processor 821 to perform an encoding or embedding process on an input from a user, which may be a prompt, for example, a text prompt or an image prompt. According to some embodiments, processor 821 executing encoding module may be caused to generate a prompt representation based on user input. For example, this may be done by determining a lower-dimensional representation of the input that may be interpretable by a machine learning trained model for generating or editing an image. The prompt representation may be determined using a text encoder such as OpenAI's CLIP text encoder. The prompt embedding may be an encoding or embedding of a prompt stored in prompt data 831, for example. In some embodiments, the prompt representation may be generated by executing a tokenization process. The encoding module may be configured to output prompt embeddings for use by the denoising module 836 or the noise predictor module 837.

Executing latent module 839 may cause processor 821 to initialise a latent of the image. This may be used to convert an original input image, such as an image retrieved or accessed from image data 830, into a latent representation, which provides a representation of the image in the latent space. In some embodiments, the latent module 839 is configured to convert the latent representation back to an image in the pixel space. According to some embodiments, the latent module 839 may be configured to adjust the resolution of the supplied image so that number of pixels in the working resolution image is a multiple of 32. Latent module 839 may function as an encoder to initialise the latent representation of an image to be edited, and as a decoder to transform the latent representation back into the pixel space of the original image. In some embodiments the latent module 839 may include a resolution adjustment module configured to adjust the working resolution of the input image and/or a visual noise module configured to apply noise.

In some embodiments, the latent module 839 may include a neural network. In some embodiments, the neural network may be a variational autoencoder (VAE) neural network. The VAE may include an encoder and/or a decode, in which the encoder is configured to compress the image to a lower dimensional representation in the latent space, generating a latent representation, and the decoder is configured to restore the image from the latent space back to the pixel space. In some embodiments, the latent module 839 is configured to initialise the latent representation by applying random noise to a latent representation of the image. In some embodiments, the latent module 839 may include a visual noise module configured to apply random noise to the latent representation. In some embodiments, the latent module 839 may be part of the denoising module 836, or it may be separate to the denoising module. The latent module 839 may be configured to initialise the latent representation of the image, and then generate new latent representations based on outputs from the blending module 838 as part of the denoising process.

Executing visual noise module may (not shown) may cause processor 821 to add randomly generated signal noise to pixel information of an accessed image to be edited and/or a latent representation of the image to be edited. The signal noise may be Gaussian noise. In some embodiments, visual noise module may be configured to add a certain level, degree or amount of visual noise to the latent representation of the image based on a noise strength parameter.

Executing denoising module 836 may cause processor 821 to perform an automated denoising process on an accessed image in order to perform an editing process.

Denoising module 836 may comprise or access a machine learning (ML) model to perform the denoising, which may be a diffusion ML model in some embodiments. A diffusion ML model may comprise a neural network model trained or otherwise configured to denoise images containing Gaussian noise by learning to reverse the diffusion process. Specifically, a diffusion ML model may be trained by adding noise to an image during a forward process until the image consists of Gaussian noise. Noise may be added to the image over a number of timesteps. In other words, the model may be trained by causing the model to destroy training data images by the successive addition of Gaussian noise, and then causing the model to recover the data by reversing the noising process. Once trained, the ML model can be used to generate image data by following a backwards or reverse process, in which the ML model starts with an image consisting of Gaussian noise and subtracts noise from the image to generate the image data, similar to that exemplified in FIG. 6.

The denoising module 836 may be configured to perform the denoising processes used in methods 320, 330, 500 and 900 discussed herein. In some embodiments, the denoising module is configured to generate an initial noise prediction, determine a set of parameters for a segment of the segmentation map generated by the segmentation map module 835 by accessing parameter data 832, and generate a modified noise prediction for the segment at a timestep t+1. The initial noise prediction and the modified noise prediction may be generated by a noise prediction module 837. In some embodiments, the noise prediction module 837 may include a U-net. The noise prediction module 837 is configured to generate noise predictions in accordance with processes discussed herein for segments which form the segmentation map. The denoising module 836 may be configured to determine a set of parameters from the parameter data 832 and generate modified noise predictions from the noise prediction module 837 for a plurality of segments. For example, executing the denoising module 836 may generate modified noise predictions for at least one protected area and at least one non-protected area. In some embodiments, the denoising module may be configured to loop through each of the plurality of segments to generate a plurality of modified noise predictions at timestep t+1 for each segment.

The denoising module 836 may further include a blending module 838. Executing the blending module 838 may cause processor 821 to perform a blending process on the modified noise predictions generated by noise prediction module 837. The noise predictions may be fed to the blending module to combine the modified noise predictions for a plurality of segments into a composite noise prediction. The blending module 838 may be configured to blend the modified noise predictions so as to ensure that the segments are more naturally combined during image editing. In some embodiments, the modified noise predictions are combined by the blending module 838 using alpha blending (a-blending). The blending module may then be configured to output the composite noise prediction to the latent module 839.

As part of the denoising process, the latent module 839 may be configured to generate a latent representation at timestep t based on the composite noise prediction for timestep t+1. The latent module may execute a process to subtract the composite noise prediction from the latent representation to generate a new latent representation at timestep t. In some embodiments, the latent module 839 is configured to update the latent representation at timestep t using each composite noise prediction generated for timestep t+1. The denoising module 836 may be configured to iteratively repeat the denoising process until a predetermined number of denoising loops have been performed, for example, where a predetermined number of sampling steps have been defined, until one or more termination criteria is met. In some embodiments, the denoising module 836 may include decrementing a timestep counter before each denoising loop is started, and stopping when the timestep counter reaches zero. In some embodiments, the denoising module may be configured to run continuously for a predetermined amount of time, iteratively repeating until the predetermined amount of time has elapsed.

Segmentation map module 835, denoising module 836, noise prediction module 837, blending module 838, latent module 839, encoding module and visual noise module, may be software modules such as add-ons or plug-ins that operate in conjunction with the image editing application 815 to expand the functionality thereof. In alternative embodiments, modules 835, 836, 837, 838, and/or 839 may be native to the image editing application 815. In still further alternative embodiments, modules 835, 836, 837, 838, and/or 839 may be stand-alone applications (running on user computing device 810, server system 820, or an alternative server system (not shown)) which communicate with the image editing application 815, such as over network 818.

Modules 835, 836, 837, 838, and/or 839 have been described and illustrated as being part of/installed on the server system 820, and may be configured as an add-on or extension to server application 834, a separate, stand-alone server application that communicates with server application 834, or a native part of server application 834. Inputs, such as user interactions, prompts, images and/or areas of features to be protected during image editing, may be provided and/or received at/by the user computing device 810, and then transferred to server system 820, such that the feature protection editing methods may be performed by the components of the server system 820.

In some alternative embodiments (not shown), the functionality provided by one or more of modules 835, 836, 837, 838, and/or 839 could be provided by user computing device 810, based on locally or remotely stored image data 830, prompt data 831, parameter data 832 and segmentation map data 819. One or more of modules 835, 836, 837, 838, and/or 839 may reside as an add-on or extension to image editing application 815, a separate, stand-alone application that communicates with image editing application 815, or a native part of image editing application 815.

In alternate embodiments (not shown), all functions, including receiving the prompt and image may be performed by the server system 820. Or, in some embodiments, an application programming interface (API) may be used to interface with the server system 820 for performing the presently disclosed methods of protecting features during image editing.

Server system 820 also comprises a communications module 827, to facilitate communication between server system 820 and other remote or external devices. Communications module 827 may allow for wired or wireless communication between server system 820 and external devices, and may use Wi-Fi, USB, Bluetooth, or other communications protocols. According to some embodiments, communications module 827 may facilitate communication between server system 820 and user computing device 810, for example.

Server system 820 may include additional functional components to those illustrated and described, such as one or more firewalls (and/or other network security components), load balancers (for managing access to the server application 833), and or other components.

In some embodiments, there is a method for feature preservation during image editing, the method comprising: accessing an image; generating a segmentation map having a plurality of segments; initialising a latent representation of the image; performing a denoising process on the latent representation, wherein the denoising process includes: generating an initial noise prediction, and for each segment of the plurality of segments: determining a set of parameters for the segment; and generating a modified noise prediction for the selected segment. After all the modified noise predictions have been generated, the method further includes combining the modified noise predictions generated for each segment to form a composite noise prediction; updating the latent representation based on the composite noise prediction; and generating an edited image from the latent representation.

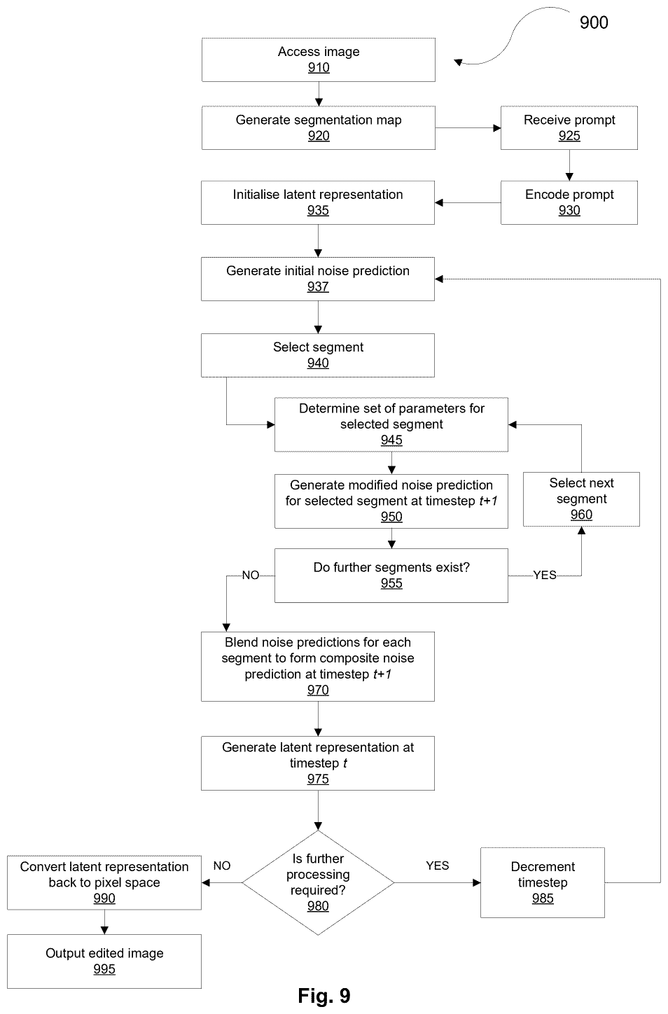

FIG. 9 is a process flow diagram of a method 900 of performing image editing with feature protection according to some embodiments. In some embodiments, method 900 may be performed at least partially by processor 811 executing image editing application 815. In some embodiments, method 900 may be performed at least partially by processor 821 executing server application 834. While certain steps of method 900 have been described as being executed by particular elements of system 800, these steps may be performed by different elements in some embodiments. Furthermore, while features of method 900 have been illustrated and described as occurring in a particular order, some of the features may be performed in an alternative order, or in parallel, without affecting the outcome of the method.

At 910, processor 821 executing server application 834 accesses an image for editing. In some embodiments, the image may be a user-selected image. The accessing may be from a memory location, from a user I/O, or from an external device in some embodiments. In some embodiments, processor 821 may access the image from image data 830.

In some embodiments, the image may be sent to server system 820 from user computing device 810. This may be in response to a user of user computing device 810 using a camera forming part of the user I/O 816 to capture an image for editing, or by the user selecting an image from a memory location. The memory location may be in memory 812 stored locally on user computing device 810, or in the data 823 in memory 822 stored remotely in server system 820. Depending on where the image editing processes are to be performed, a copy of the retrieved image may be stored to a second memory location to allow for efficient access of the image file by processor 811 and/or processor 821. For example, a copy of the image may be stored in image data 830 of memory 822 for access by processor 821. The accessed image may be displayed within a user interface of the image editing application 815, which may be displayed on a display screen (not shown) forming part of the user I/O 816.

At 920, processor 821 executing segmentation map module 920 generates a segmentation map corresponding to the accessed image to be edited. The segmentation map may contain a plurality of segments which correspond to different features of the image. In some embodiments, the segmentation map module generates the segmentation map using segmentation map data 819, by determining whether there any user selected areas have been selected, for example by receiving a user input from user I/O 816 indicating an area defined as a segment and storing this as user selected area data 819a, or by executing a detection algorithm to generate detected areas of the image and storing these as detected area data 819b. In some other embodiments, executing a detection algorithm may be an automated process to generate the segmentation map, and processor 821 may proceed to 935 without needing any user input.

At 925, processor 821 executing server application 834 receives a user input corresponding to one or more prompts relating to an edit to perform to the image accessed at 910. In some embodiments, the prompt may be a text prompt, an audio recording, a selection from a list, a multimodal prompt or any other suitable type of prompt. When the prompt is a text prompt, the prompt may be entered using a text input field, such as a text box. When the prompt is an audio recording, the audio recording may be in the form of an .MP3 or .WAV, or any other suitable audio file format.

In some embodiments, 925 may be performed before or after 920, with the segmentation map being generated after the prompt is received.

At 930, processor 821 executing encoding module is caused to determine an encoding of the prompt received at 925. The encoding may be a representation, such as a numerical representation or a token, of the prompt. In some embodiments, when the prompt is a text prompt, the encoding module may use a text encoder to determine, from the prompt, a numerical value and/or a set or series of numerical values that are indicative of the meaning or content of the prompt. The encoding module may use any suitable text encoder/texting encoding process, such as frequency document vectorization, one-hot encoding, index-based encoding, word embedding, or contrastive language-image pre-training (CLIP) to determine the encoding. In some embodiments encoding module may use a CLIP ViT-L/14 text encoder to determine the encoding of the prompt.

In some embodiments, when the prompt is an audio file, processor 821 executing encoding module may be caused to determine a textual representation of the audio recording before performing the encoding step. The textual representation of the audio recording may be determined using a speech to text ML model, such as Google speech-to-Text, DeepSpeech, Kaldi, or Wav2Letter, or any other suitable speech to text ML model.

According to some embodiments, 930 may be performed at any point after a prompt is received at 925 and before the denoising loop begins at 940.

At 935, processor 821 executing latent module 939 may initialise a latent representation of the image to be edited. The latent representation may be initialised by changing the working resolution of the image to be edited from the pixel space to the latent space. In some embodiments, initialising the latent representation at 935 may include executing a noise module to apply visual noise to the image to be edited. The visual noise may be generated by adding randomly generated visual noise to the image portion to be edited. In some embodiments, the noise may be Gaussian noise. In some embodiments, the visual noise is generated by replacing the pixel information of the image portion to be edited completely with visual noise. In other words, the entire set of pixel information or latent representation of the pixel information may be deleted and replaced with visual noise. In some embodiments, applying noise to the latent representation includes generating a random tensor in latent space (latent noise), and corrupting the latent representation with the latent noise.

Visual noise may refer to a variance, such as a random variance, in the attributes/qualities of the pixel information or a latent representation of the pixel information of an image. The attributes of the pixel information or a latent representation of the pixel information of an image may be brightness, colour (e.g. colour model), dimension, bit depth, hue, chroma (saturation), and/or value (lightness). The visual noise may comprise a plurality of pixels that have had their information randomly altered/varied. In some embodiments, the visual noise may be Gaussian noise, which is a type of signal noise that has a probability density function equal to that of the normal distribution (also known as the Gaussian distribution). In some embodiments, the Gaussian visual noise may be white Gaussian noise, in which the values at any pair of times are identically distributed and statistically independent (and hence uncorrelated). In some embodiments, noise may be added multiple times at a relatively low standard deviation.

937 to 985 of method 900 comprise a denoising loop, in which a backwards diffusion process is used to transform the latent representation initialised at 935 into an image based on the prompt received at 925 through a series of predictions generated by a ML model, whilst preserving particular features of the image during the editing process. Each pass through the denoising loop comprises a timestep in the denoising process, which is considered a backwards step in reference to a time t.

The steps performed during the denoising loop described below with reference to 937 to 985 enhance the image editing process by protecting or limiting the effect of the editing process on particular features or aspects of the image. Specifically, the denoising process is configured to preserve features of the original image during the editing process by controlling the weight which is applied towards the prompt for which each pixel is to be edited, whilst still enabling the image to be edited in accordance with the text prompt. This reduces undesirable effects such as over-editing of the image, or bias appearing in image editing, as shown in the examples of FIGS. 1A to 1C and 2A to 2B.

Immediately prior to the start of the denoising loop can be considered to be at a timestep t+1, where the latent at timestep t+1 is the visual noise generated at 935. As the denoising loop is a backwards process, each iteration of the loop concludes with the timestep moving backwards, so that t=t−1. In other words, adding to the timestep results in increased noise, while reducing the timestep results in decreased noise. The start of the denoising loop therefore occurs at a timestep t.

At 937, processor 821 executing the noise prediction module 837 is caused to generate an initial noise prediction for the input image at a timestep t+1. For example, the noise prediction module 837 predicts the noise that would have been added to the current latent during a timestep t+1, were a noising process to have been carried out on an edited image as described by the encoded prompt to generate the current latent representation. Processor 821 may perform this by providing the latent initialised at 935, and the prompt as encoded at 930 to a ML model trained to perform a denoising process, and/or utilising the noise prediction processes and formulas described herein.

At 940, processor 821 executing the noise prediction module 837 may select a segment from the segmentation map. The selection of a segment defines the start of a segment selection loop, which enables the method 900 to loop through each segment of the generated segmentation map. For each segment, at 945 a set of parameters is determined for the selected segment data. The set of parameters may be determined by accessing the parameter data 832, including guidance scale data 833a and image guidance scale data 833b. The set of parameters are then used to generate a modified noise prediction for the selected segment at a timestep t+1.

At 950, processor 821 executing denoising module 836 is caused to modify the initial predicted noise that would have been added to the current latent during a timestep t+1, were a noising process to have been carried out on an edited image as described by the encoded prompt to generate the current latent representation. Processor 821 may perform this by providing the latent initialised at 935, the segments from the segmentation map generated at 920, the set of parameters for each segment determined at 945, and the prompt as encoded at 930 to a ML model trained to perform a denoising process, and/or utilising the noise prediction processes and formulas described herein.

After generating the modified noise prediction for a selected segment, a determination is made at 955 to determine whether further segments exist for which a modified noise prediction should be generated. This determination may be made by accessing the segmentation map data 819. If further segments are determined to exist, at 960 the next segment is selected, and the noise modified predictions are generated for those segments. This segment selection loop repeats until no further segments exist in the segmentation map for which no modified noise prediction has been generated. When it is determined that no further segments exist for which a modified noise prediction should be generated, then the method proceeds to 970.

At 970, processor 821 executing blending module 838 blends the modified noise predictions for each of the segments generated at 950 to form a composite noise prediction at timestep t+1. The blending module 838 may alpha blend the modified noise predictions to form the composite noise prediction.

At 975, processor 821 executing latent module 839 as part of the denoising module 836 is caused to generate the latent representation for a current timestep t. This is generated based on the composite noise prediction formed at 970 and the latent representation at timestep t+1. Specifically, the latent representation at timestep t is calculated by subtracting the composite noise prediction generated at 970 from the latent representation at timestep t+1. The latent representation at timestep t is therefore less noisy than the latent representation at timestep t+1.

After generating an updated latent representation at timestep t, at 980, processor 821 executing denoising module 836 determines whether further processing is required.

According to some embodiments, denoising module 836 may be configured to perform a predetermined number of denoising cycles, and so 980 may comprise comparing the number of denoising cycles that have been performed with the predetermined number of denoising cycles that are to be performed. According to some embodiments, between 15 and 40 denoising cycles may be performed. In some embodiments, between 20 and 30 denoising cycles may be performed. For example, around 20, 25 or 30 denoising cycles may be performed.

If processor 821 determines that further denoising steps are to be performed, then processor 821 proceeds to 985. At 985, processor 821 executing denoising module 836 is caused to start a new denoising loop by decrementing the timestep. For example, this may include setting the timestep t as t−1.

If processor 821 determines that no further denoising steps are to be performed, then processor 821 proceeds to perform 990 using the most recently generated latent representation generated at 975.

At 990, processor 821 executing latent module 839 restores the resolution of the most recent latent representation to be equivalent to the resolution of the original image accessed at 910.

At 995, processor 821 executing server application 834 is caused to output the edited image. This may be by performing one or more of saving the image to memory 812, memory 822 or an external memory location; by sending the image to an external device for storage or display, and/or by displaying the image via user I/O 816 of user computing device 810.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for editing an image, the method comprising:
accessing an image;
identifying at least a first area of the image and a second area of the image;
configuring a diffusion model to generate an edited image based on the first area of the image and the second area of the image, wherein the edited image comprises a first area of the edited image and a second area of the edited image;
wherein the diffusion model is configured to generate the edited image such that the first area of the edited image differs from the first area of the image less than the second area of the edited image differs from the second area of the image.

2. The method according to claim 1, wherein configuring the diffusion model to generate an edited image includes performing a denoising process on the image.

3. The method according to claim 1, wherein configuring the diffusion model to generate an edited image includes:
initialising a latent representation of the image;
performing a denoising process on the latent representation; and
generating an edited image from the latent representation.

4. The method according to claim 3, wherein initialising the latent representation of the image includes converting the image from a pixel space to a latent space and applying random noise.

5. The method according to claim 1, wherein configuring the diffusion model to generate an edited image includes:
determining a first set of parameters for the first area of the image; and
determining a second set of parameters for the second area of the image.

6. The method according to claim 5, wherein performing a denoising process on the latent representation includes:
generating an initial noise prediction for the image;
determining the first set of parameters for the first area of the image;
modifying the initial noise prediction corresponding to the first area based on the first set of parameters to generate a first modified noise prediction;
determining the second set of parameters for the second area of the image;
modifying the initial noise prediction corresponding to the second area based on the second set of parameters to generate a second modified noise prediction;
combining the first modified noise prediction and the second modified noise prediction to form a composite noise prediction; and
updating the latent representation based on the composite noise prediction.

7. The method according to claim 6, wherein the denoising process further includes:
determining whether further processing of the latent representation is required; and
responsive to determining that further processing is required, repeating the denoising process on the latent representation.

8. The method according to claim 6, further including repeating the denoising process over a series of timesteps, or for a predetermined period of time.

9. The method according to claim 8, wherein given a current timestep t, generating an initial noise prediction includes predicting the visual noise that would be present in the latent representation at a timestep t+1 during a noising process.

10. The method according to claim 9, wherein the timestep t is decremented after each iteration of the denoising process.

11. The method of claim 5, wherein the second set of parameters is at least partially different to the first set of parameters.

12. The method according to claim 5, wherein each of the first set of parameters and the second set of parameters include at least a guidance scale parameter and an image guidance scale parameter.

13. The method of claim 6, wherein generating an initial noise prediction includes using the equation:
$$noise\_pred = ( noise\_pred \_uncond + guidance\_scale * ( noise\_pred \_text - noise\_pred \_image ) + image\_guidance \_scale * ( noise\_pred \_image - noise\_pred \_uncond ) )$$
wherein noise_pred_uncond represents noise without conditioning;
noise_pred_image represents noise conditioned by the image;
noise_pred_text represents noise condition by a text prompt;
guidance_scale represents a guidance scale parameter; and
image_guidance_scale represents an image guidance scale parameter.

14. The method of claim 13, wherein modifying the initial noise prediction includes using the equation:
$$noise\_pred \_modified = ( modified\_guidance \_scale * text\_guidance \_difference + modified\_image \_guidance \_scale * image\_guidance \_difference )$$
wherein modified_guidance_scale represents a modified guidance scale parameter;
modified_image_guidance_scale represents a modified image guidance scale parameter;
$$text\_guidance \_difference = noise\_pred \_image - noise\_pred \_uncond ; and$$
$$text\_guidance \_difference = noise\_pred \_text - noise\_pred \_image .$$

15. The method according to claim 6, wherein modifying the initial noise prediction includes extrapolating the initial noise prediction based on the first set of parameters or the second set of parameters.

16. The method according to claim 6, wherein combining the first modified noise prediction and the second modified noise prediction includes alpha blending the first modified noise prediction and the second modified noise prediction.

17. The method according to claim 6, wherein updating the latent representation based on the composite noise prediction includes subtracting the composite noise prediction from the latent representation to generate a new latent representation.

18. The method according to claim 6 further including identifying a plurality of areas of the image and determining a set of parameters for each of the plurality of areas.

19. The method according to claim 6, wherein identifying the at least one first area and the second area includes generating a segmentation map, wherein the segmentation map includes a plurality of segments and each segment of the plurality of segments represents a segmentation mask.

20. The method according to claim 19, wherein the denoising process includes:
selecting a segment from the plurality of segments in the segmentation map;
determining a set of parameters for the selected segment;
generating a modified noise prediction for the selected segment;
determining whether further segments exist; and
responsive to further segments existing, selecting the next segment.
